(19) United States
(12) Patent Application Publication
(10) Pub. No.: US 2026/0008394 A1
(43) Pub. Date: Jan. 8, 2026

(54) DEPLOYABLE OTTOMAN FOR FOOTREST, CALF SUPPORT, STORAGE, AND INTERIOR CAMERAS AND PREDICTIVE ALGORITHMS

(71) Applicant: GM GLOBAL TECHNOLOGY OPERATIONS LLC, Detroit, MI (US)

(72) Inventors: William Cavalcante Araujo, La Verne, CA (US); Frank Rudolph, Los Angeles, CA (US)

(73) Assignee: GM GLOBAL TECHNOLOGY OPERATIONS LLC, Detroit, MI (US)

(21) Appl. No.: 18/762,469

(22) Filed: Jul. 2, 2024

(51) Int. Cl. B60N 2/90

(52) U.S. Cl. CPC B60N 2/995; B60N 2220/10

(57) ABSTRACT

Disclosed is a deployable ottoman operatively connected to an electric motor to move the deployable ottoman. The deployable ottoman may be connected to a floorboard of a vehicle and moved by the electric motor from a first position to a second position for use by an occupant of the vehicle. A vehicle may be provided with at least one internal camera and a microphone which may communicate with a control system to move the deployable ottoman in the vehicle based on determinations of an occupant's height, leg position, and seat position. The control system may move the deployable ottoman in response to voice commands or input to a control device.

### INTRODUCTION

The technical field generally relates to deployable ottomans, footrests, calf supports, and to storage in a vehicle and methods of making and using the same.

Vehicles in the future will have vastly different interior designs and may relocate the steering wheel, brake pedal, gas pedal or eliminate the same in the passenger cabin. These changes will bring demands for changes and occupant accommodation in the passenger cabin.

Accordingly, it is desirable to provide features in the passenger cabin that enhance occupant accommodations. Furthermore, other desirable features and characteristics of the patentable variations will become apparent from the subsequent detailed description and the appended claims, taken in conjunction with the accompanying drawings and the foregoing introduction.

### SUMMARY

A number of variations may include a method including: providing a computing device including electronic processor, a non-transitory storage medium, written instructions stored on the non-transitory storage medium and executable by the electronic processor. The written instructions when executed by the electronic processor perform acts including: receiving, by the computing device, a request for activation a deployable ottoman, wherein the deployable ottoman is operatively connected to at least one track to move along a vehicle floorboard by an electric motor operatively connected to the deployable ottoman. Also, receiving, by the computing device, data from at least one camera and using the data to determine an occupant's body characteristics, leg positions, and seating position. Also, receiving, by the computing device, a request for the deployable ottoman to function as a footrest, to gain access to a storage area defined in the deployable ottoman, or to function as a calf rest. Also, sending, by the computing device, a signal to the deployable ottoman to move to a position in response to the occupant's body characteristics, leg positions, and seating position and in response to the request for the deployable ottoman to function as a footrest, to gain access to a storage area defined in the deployable ottoman, or to function as a calf rest.

A number of variations may include a method wherein the sending, by the computing device, the signal to the deployable ottoman causes the deployable ottoman to move to a position to function as requested.

A number of variations may include a method further including sending, by the computing device, a communication to a vehicle occupant prompting the vehicle occupant to confirm that the deployable ottoman is in a position to function as requested.

A number of variations may include a method further including receiving, by the computing device, confirmation that the position of the deployable ottoman is in a position to function as requested.

A number of variations may include a method further including putting the computing device in standby mode awaiting a request to move the deployable ottoman to a collapse position, a storage position, another position, or to provide another function.

A number of variations may include a method further including receiving, by the computing device, input from the vehicle occupant that the deployable ottoman is not in a position to function as requested.

A number of variations may include a method further including determining, by the computing device, a recalibrated position to move the deployable ottoman to function as requested and causing the deployable ottoman to move to the recalibrated position.

A number of variations may include a method further including sending, by the computing device, another communication to the vehicle occupant prompting the vehicle occupant to confirm that the deployable ottoman is in a position to function as requested.

A number of variations may include a method further including receiving, by the computing device, confirmation that the position of the deployable ottoman is in a position to function as requested and in response thereto putting the computing device in standby mode awaiting a request to move the deployable ottoman to a collapsed position, a storage position, another position, or to provide another function.

A number of variations may include a method further including receiving, by the computing device, input from the vehicle occupant that the deployable ottoman is not in a position to function as requested and in response thereto sending a communication to the vehicle occupant recommending fine-tuning the position of the deployable ottoman be done by the vehicle occupant via electronic controls.

A number of variations may include a vehicle including: a vehicle floorboard having at least one track formed therein, a deployable ottoman operatively connected to the at least one track to move along the vehicle floorboard, an electric motor operatively connected to the deployable ottoman to move the deployable ottoman in a first direction and a second direction. The vehicle may have a cabin, and at least one camera, the camera operatively connected to a control system including a computing device including an electronic processor, a non-transitory storage medium, written instructions stored on the non-transitory storage medium and executable by the electronic processor. The control system may be configured to provide functionality including: receiving, by the computing device, a request for activation the deployable ottoman. Also, receiving, by the computing device, data from the at least one camera and using the data to recognize an occupant's body characteristics, leg positions, and seating position. Also, receiving, by the computing device, a request for the deployable ottoman to function as a footrest, to gain access to a storage area defined in the deployable ottoman, or to function as a calf rest. Also, sending, by the computing device, a signal to the deployable ottoman to move to a position in response to the occupant's body characteristics, leg positions, and seating position and in response to the request for the deployable ottoman to function as a footrest, to gain access to a storage area defined in the deployable ottoman, or to function as a calf rest.

A number of variations may include a vehicle wherein the sending, by the computing device, the signal to the deployable ottoman causes the deployable ottoman to move to a position to function as requested.

A number of variations may include a vehicle further including sending, by the computing device, a communication to an occupant of the vehicle prompting the occupant to confirm that the deployable ottoman is in a position to function as requested.

A number of variations may include a vehicle further including receiving, by the computing device, confirmation that the position of the deployable ottoman is in a position to function as requested.

A number of variations may include a vehicle further including putting the computing device in standby mode waiting for a request to move the deployable ottoman to a collapse position, a storage position, another position, or to provide another function.

A number of variations may include a vehicle further including receiving, by the computing device, input from the occupant of the vehicle that the deployable ottoman is not in a position to function as requested.

A number of variations may include a vehicle further including determining, by the computing device, a recalibrated position to move the deployable ottoman to function as requested and causing the deployable ottoman to move to the recalibrated position.

A number of variations may include a vehicle further including receiving, by the computing device, confirmation that the position of the deployable ottoman is in a position to function comfortably as requested and in response thereto putting the computing device in standby mode waiting for a request to move the deployable ottoman to a collapse position, a storage position, another position, or to provide another function.

A number of variations may include a vehicle further including receiving, by the computing device, input from the occupant that the deployable ottoman is not in a position to function as requested and in response thereto sending a communication to the occupant recommending fine-tuning the position of the deployable ottoman be done by the occupant via electronic controls.

A number of variations may include a vehicle including: a vehicle floorboard having at least one track formed therein, a deployable ottoman operatively connected to the at least one track to move along the vehicle floorboard, an electric motor operatively connected to the deployable ottoman to move the deployable ottoman in a first direction and a second direction. The vehicle may have a cabin, and at least one camera, the camera operatively connected to a control system including a computing device including electronic processor, a non-transitory storage medium, written instructions stored on the non-transitory storage medium and executable by the electronic processor. The control system may be configured to provide functionality including: receiving, by the computing device, a request for activation the deployable ottoman. Also, receiving, by the computing device, data from the at least one camera and using the data to recognize an occupant's body characteristics, leg positions, and seating position. Also, receiving, by the computing device, a request for the deployable ottoman to function as a footrest, to gain access to a storage area defined in the deployable ottoman, or to function as a calf rest. Also, sending, by the computing device, a signal to the deployable ottoman to move to from a first position to a second position in response to the occupant's body characteristics, leg positions, and seating position and in response to the request for the deployable ottoman to function as a footrest, to gain access to a storage area defined in the deployable ottoman, or to function as a calf rest. And wherein the vehicle may include at least one of a display screen, a trim panel, a door, or a movable display screen, and in the first position the deployable ottoman is at least one of: flush with the display screen or the trim panel positioned in front of a seat in the vehicle, underneath the trim panel or the display screen positioned in front of the seat in the vehicle, hidden behind the door positioned underneath the display screen or the trim panel positioned in front of the seat in the vehicle, or hidden behind the movable display screen in front of the seat in the vehicle. Wherein the at least on camera may be mounted one of an A-pillar, a headliner, an instrument panel or a door trim panel of the vehicle, and wherein the vehicle comprises a navigation system integrated with the ottoman to inform the occupant that the vehicle is approaching its destination and request that the occupant confirm that the occupant is ready for the ottoman to be collapsed or stored to make room for the occupant to exit the vehicle comfortably

### BRIEF DESCRIPTION OF THE DRAWINGS

The illustrative variations will hereinafter be described in conjunction with the following drawing figures, wherein like numerals denote like elements, and wherein:

FIG. 1 is a perspective view of a vehicle with portions removed showing a deployable ottoman in a first position stored in a fashion integrated or flush with a display screen or trim panel and positioned a first distance from an occupant seat according to a number of variations;

FIG. 2 is a perspective view of a vehicle with portions removed showing a deployable ottoman in a second position at a second distance from the occupant seat to function as a footrest for an occupant of the vehicle, wherein the deployable ottoman is at a first height nearest to the vehicle floorboard according to a number of variations;

FIG. 3 is a perspective view of the vehicle with portions removed showing a deployable ottoman in a second position at a second distance from the occupant seat, the deployable ottoman having a top wall pivoted to an open position to allow access to a storage space defined in the deployable ottoman according to a number of variations;

FIG. 4 is a perspective view of a vehicle with portions removed showing a deployable ottoman in a second position at a second distance from the occupant seat to function as a calf support according to a number of variations;

FIG. 5 is a perspective view of a vehicle with portions removed showing a deployable ottoman at a second position and wherein the deployable ottoman is at a second height lifted from the vehicle floorboard according to a number of variations;

FIG. 6 is a perspective view of a deployable ottoman with a top wall in an open position according to a number of variations;

FIG. 7 is a schematic illustration of a control system for operating a deployable ottoman according to a number of variations;

FIG. 8 is a schematic illustration of a portion of a vehicle including portions of a pair of tracks formed in a floorboard of the vehicle for use in moving a deployable ottoman according to a number of variations;

FIG. 9 is a schematic side view of a portion of a deployable ottoman operatively connected to an electric motor for selectively moving a deployable ottoman according to a number of variations;

FIG. 10 is a schematic side view of a portion of a deployable ottoman operatively connected to a motor for selectively moving a deployable ottoman according to a number of variations;

FIG. 11 is a perspective and schematic illustration of a system for linear movement of a deployable ottoman according to a number of variations;

FIG. 12 is a perspective view of a vehicle with portions removed showing a deployable ottoman in a stored position underneath and behind a trim panel according to a number of variations;

FIG. 13 is a perspective view of a vehicle with portions removed showing a deployable ottoman and a stored position underneath a display screen or trim panel according to a number of variations;

FIG. 14 is a perspective view of a vehicle with portions removed showing a deployable ottoman hidden behind a door underneath the display screen or trim panel according to a number of variations;

FIG. 15 is a perspective view of a vehicle with portions removed showing a deployable ottoman with a door panel retracted to make room for the deployable ottoman underneath a trim panel or display screen according to a number of variations;

FIG. 16 is a perspective view of a vehicle with portions removed showing a deployable ottoman wherein a door panel is completely retracted to reveal the deployable ottoman;

FIG. 17 is a perspective view of the vehicle with portions removed showing a movable display screen or trim panel at a position to hide in deployable ottoman behind the movable display screen or trim panel according to a number of variations;

FIG. 18 is a perspective view of a vehicle with portions removed showing a movable display screen or trim panel moved in a vertical direction away from the vehicle floorboard to expose a portion of the deployable ottoman according to a number of variations;

FIG. 19 is a perspective view of the vehicle with portions removed showing the movable display screen or trim lowered to a position nearest the vehicle floorboard and wherein the deployable ottoman is in a second position at a second distance from an occupant seat to function as a calf support for an occupant according to a number of variations;

FIG. 20 is a flow diagram illustrating a method of operating a deployable ottoman in a vehicle according to a number of variations; and

FIG. 21 is a flow diagram illustrating a method of operating a deployable ottoman in a vehicle according to a number of variations.

### DETAILED DESCRIPTION

The following detailed description is merely exemplary in nature and is not intended to limit the application and uses. Furthermore, there is no intention to be bound by any expressed or implied theory presented in the preceding introduction, brief description of the drawings, brief summary or the following detailed description.

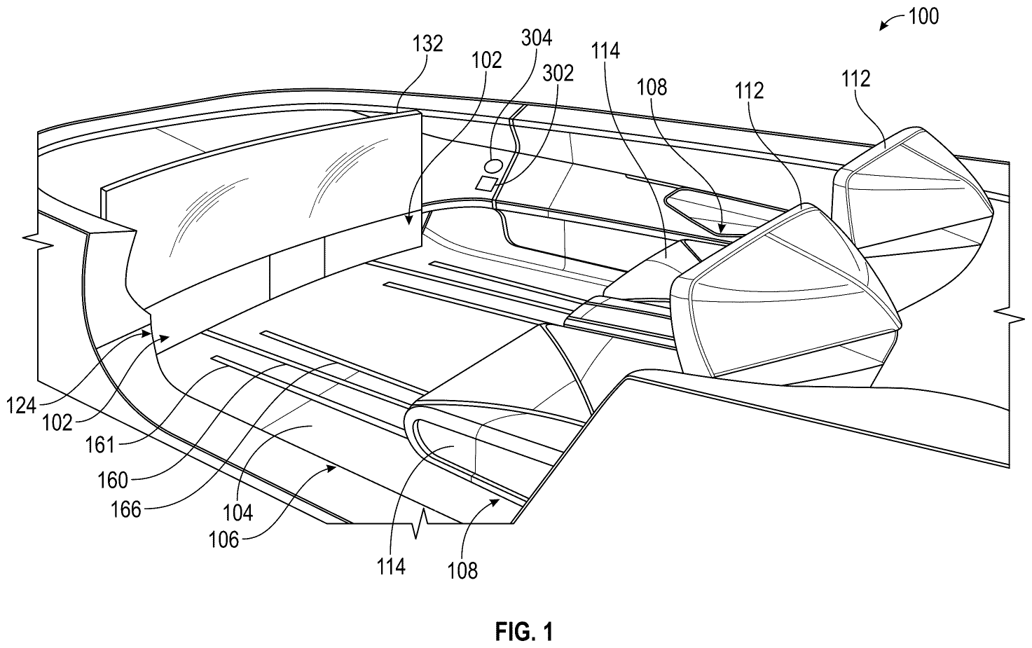

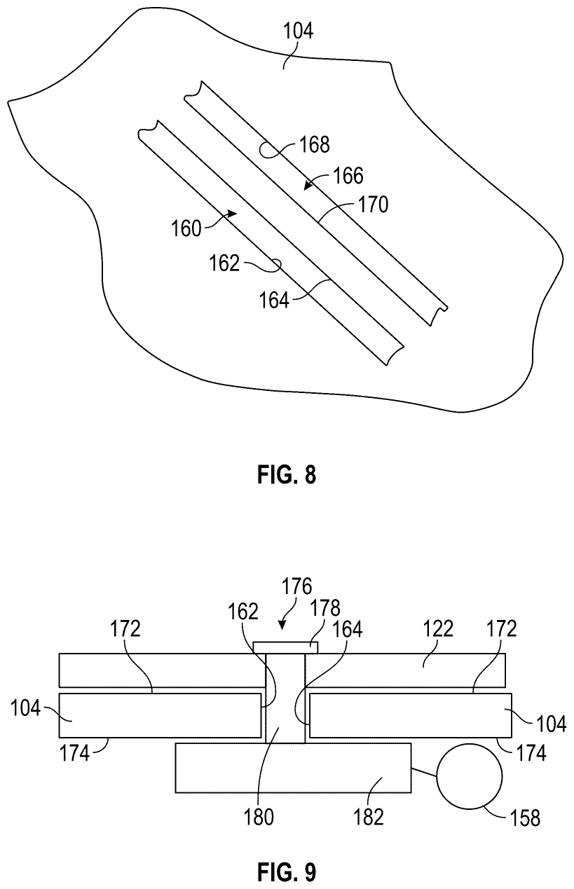

FIG. 1 is a perspective view of a vehicle 100 with portions removed showing a deployable ottoman 102 in a first position 124 stored in a fashion integrated or flush with a display screen 132 or trim panel and positioned a first distance from a seat 108 according to a number of variations. FIGS. 1-6, 8 and 11-12 illustrate a number of variations, which may include a deployable ottoman 102 operatively connected to an electric motor 158 to move the deployable ottoman 102. In a number of variations, the deployable ottoman 102 may be positioned in a vehicle 100 so that the deployable ottoman 102 may be moved by the electric motor 158 along a first track 160 and/or a second track 166 and/or a third track 161 formed in a vehicle floorboard 104 (best seen in FIG. 8). A seat 108 may be provided in the passenger cabin 106 to support an occupant (not shown). The seat 108 may include a seat back 112 and a bottom cushion 114. The deployable ottoman 102 may be movable from a first position 124 a first distance away from the seat 108 to a second position 126 which is a second distance away from the seat 108. The second position 126 may be closer to the seat 108 than the first position 124. The first position 124 may be such that the deployable ottoman 102 is adjacent to a display screen 132 or may be behind the display screen 132. In a number of variations, the passenger cabin 106 may not include a steering wheel, brake pedal, or propulsion pedal. In a number of variations, the vehicle 100 may be capable of autonomous driving wherein a passenger such as the driver of the vehicle does not need to control the vehicle using a steering wheel, brake pedal, or propulsion pedal. In a number of variations, the vehicle 100 may operate in an autonomous or semi-autonomous manner using control logic executed by a control system using an electronic processor, non-transitory digital storage medium with written instructions stored thereon executable by the electronic processor. Control of the vehicle may at times be achieved by a human driver using any of a variety of devices such as, but not limited to, a joystick, voice controls, displays, or buttons without using a traditional steering wheel, brake pedal or propulsion pedal. One or more cameras 302 and one or more microphones 304 may be position in the interior of the vehicle 100 and may be operatively connected to a control system (described in more detail hereafter) to move the deployable ottoman 102 to various positions based on determinations, made by the control system, of an occupant's height, position of one or more occupant legs, and the occupant's seated position. The deployable ottoman 102 may also be moved by voice commands or by inputs provided by an occupant using a control device (described in more detail hereafter).

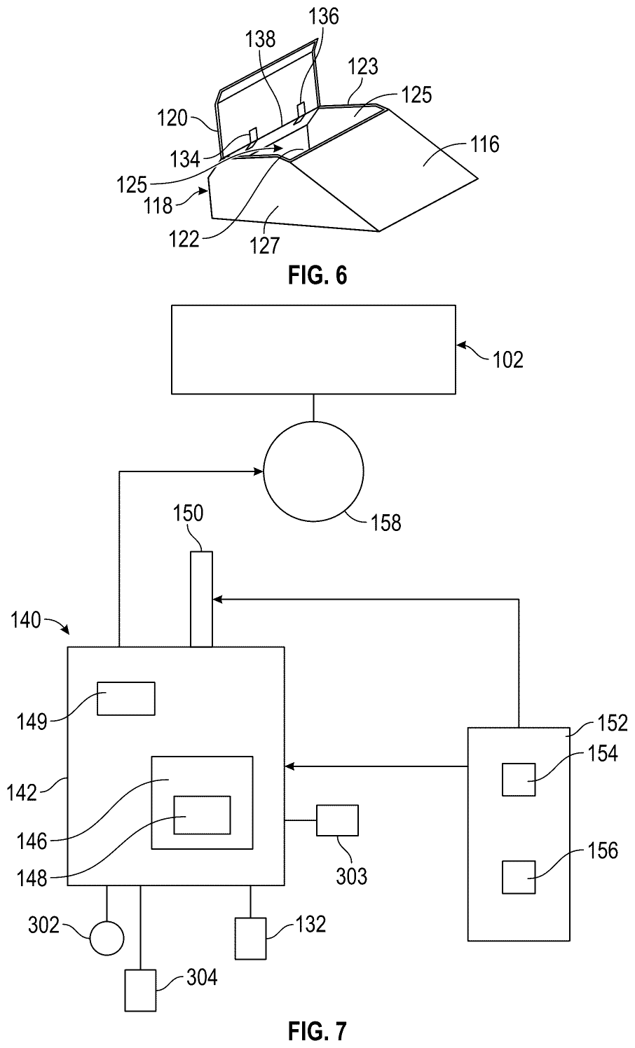

As best seen in FIG. 6, the deployable ottoman 102 may include a front wall 116 and a back wall 118, a first sidewall 123 and an opposite second side wall 127, and a top wall 120, which may extend between the front wall 116, the back wall 118, the first sidewall 123 and the second side wall 127. An occupant (not shown) may lift the top wall 120 of the deployable ottoman 102 to gain access to a storage space 125 defined in the deployable ottoman 102. The top wall 120 may be pivotally connected to one of the back wall 118, first sidewall 123 or the opposite second side wall 127. In a number of variations, the top wall 120 may be pivotally connected by a first hinge 134 and/or a second hinge 136 each joining with the top wall 120 and the back wall 118. In an alternative variation, a flexible hinge 138 may be provided between the top wall 120 and one of the back wall 118, first sidewall 123 or the opposite second side wall 127. The flexible hinge 138 may be made from the same material as the top wall 120 but of a thinner thickness sufficient to function as a hinge. In a number of variations, the flexible hinge 138 may be made from a material different than the top wall 120. In a number of variations, the top wall 120 may be opened and closed manually or by electric motor controlled by the control system 140, as described in more detail hereafter.

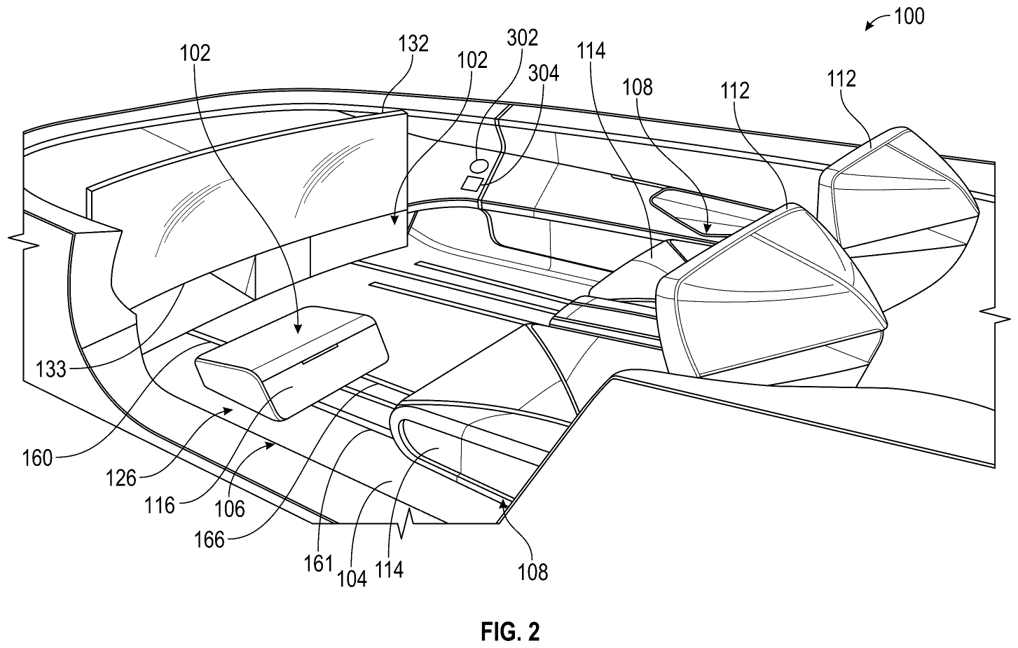

As illustrated in FIG. 2, the deployable ottoman 102 may be moved from a first position 124 (shown in FIG. 1) to a second position 126 so an occupant may use the front wall 116 of the deployable ottoman 102 as a footrest.

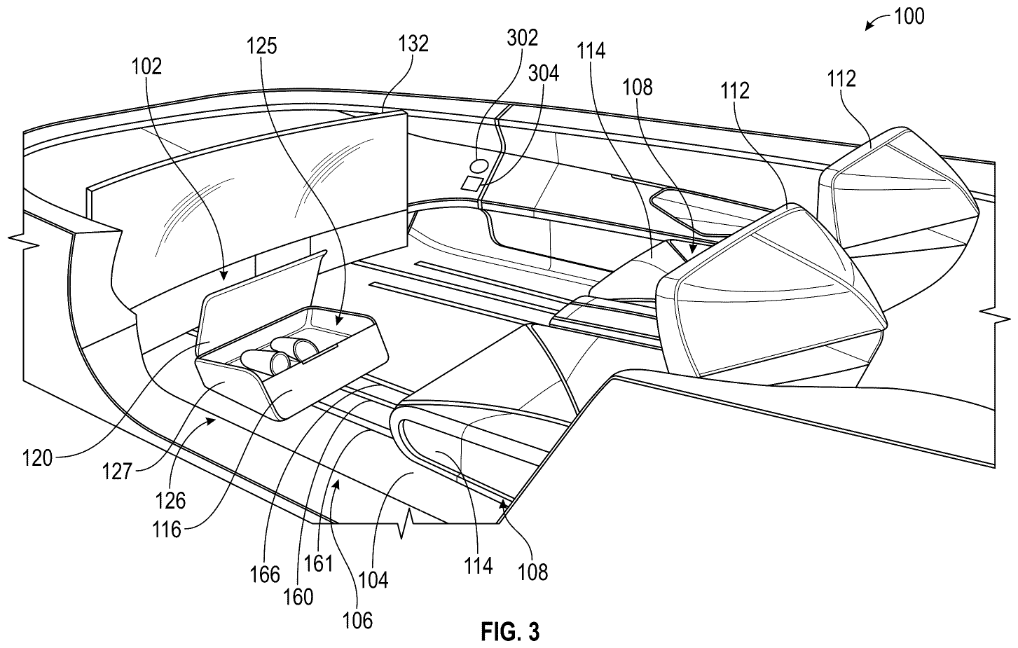

As illustrated in FIG. 3, the deployable ottoman 102 may be moved from a first position 124 (shown in FIG. 1) to a second position 126 so an occupant (not shown) may reach the top wall 120 and pivot the top wall 120 upward to open the deployable ottoman 102 and gain access to storage space 125 defined in the deployable ottoman 102. The seat back 112 of the seat 108 may be moved, manually or by an electric motor, to an upright position which may reduce the distance an occupant (not shown) must move to reach into the deployable ottoman 102 than if the seat back 112 was in the reclined position. As described hereafter, at least a first portion 101 of the deployable ottoman 102 may be lifted to make it easier for an occupant to reach the top wall 120 and gain access to the storage space 125 defined in the deployable ottoman 102.

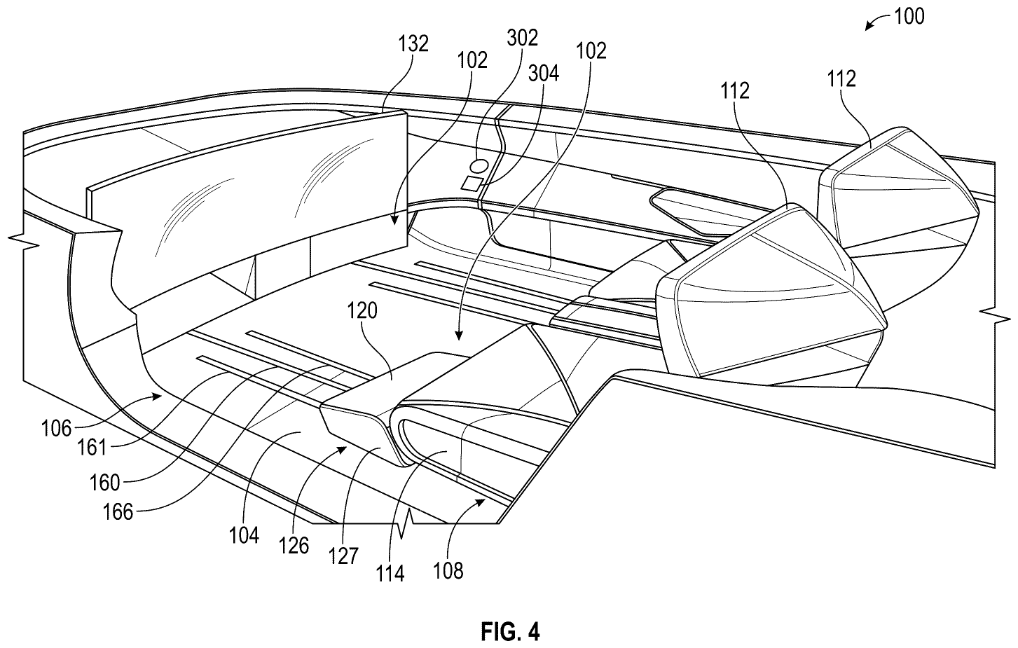

As illustrated in FIG. 4, the deployable ottoman 102 may be moved to a second position 126 at a second distance from the seat 108 so that the top wall 120 of the deployable ottoman 102 functions as a calf support according to a number of variations.

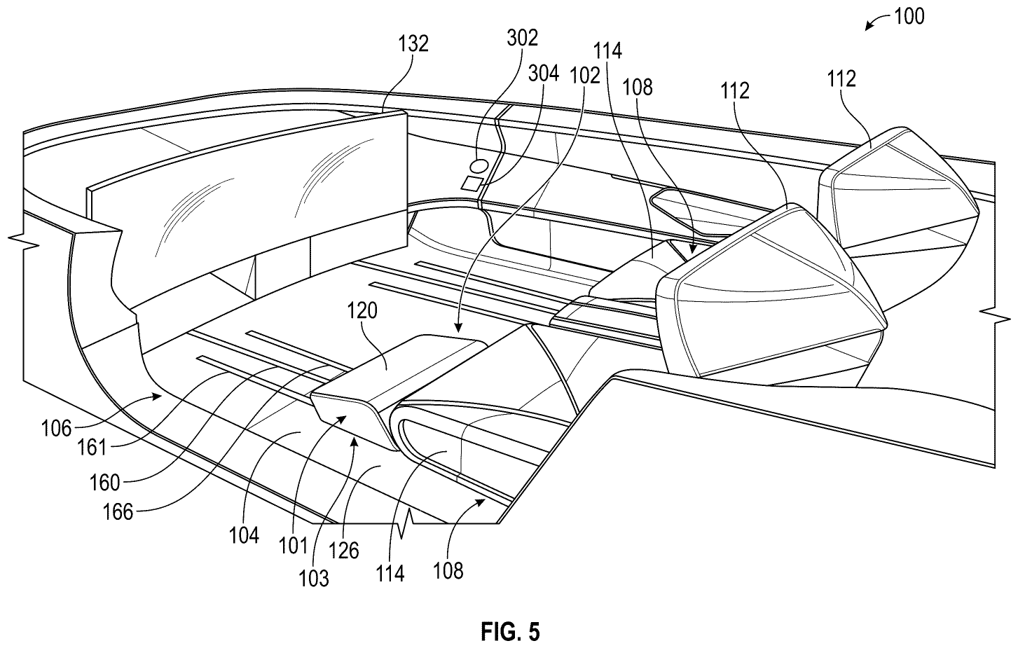

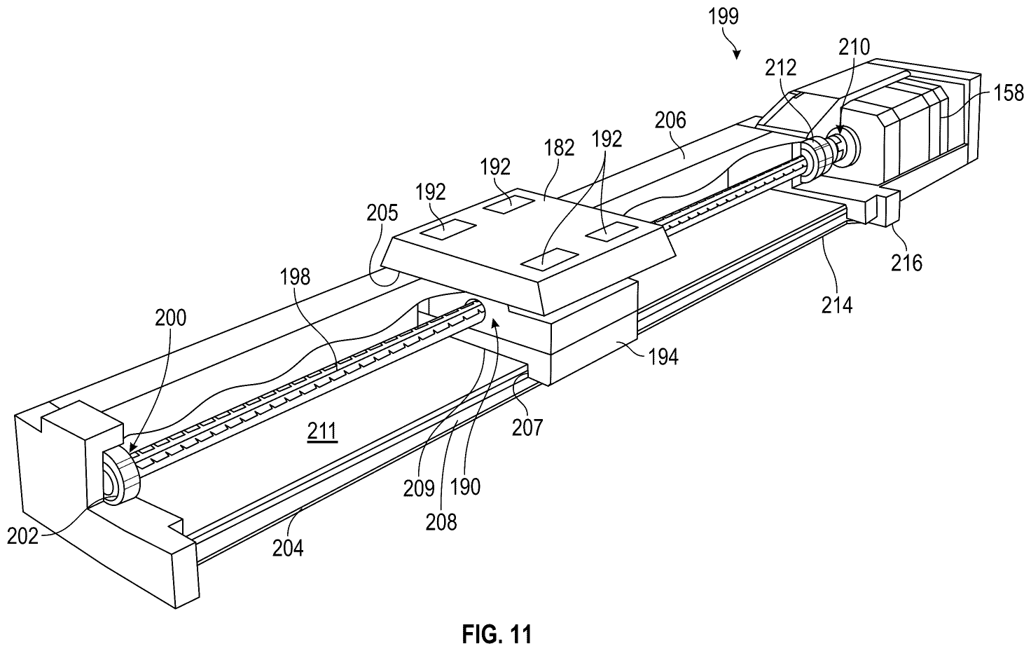

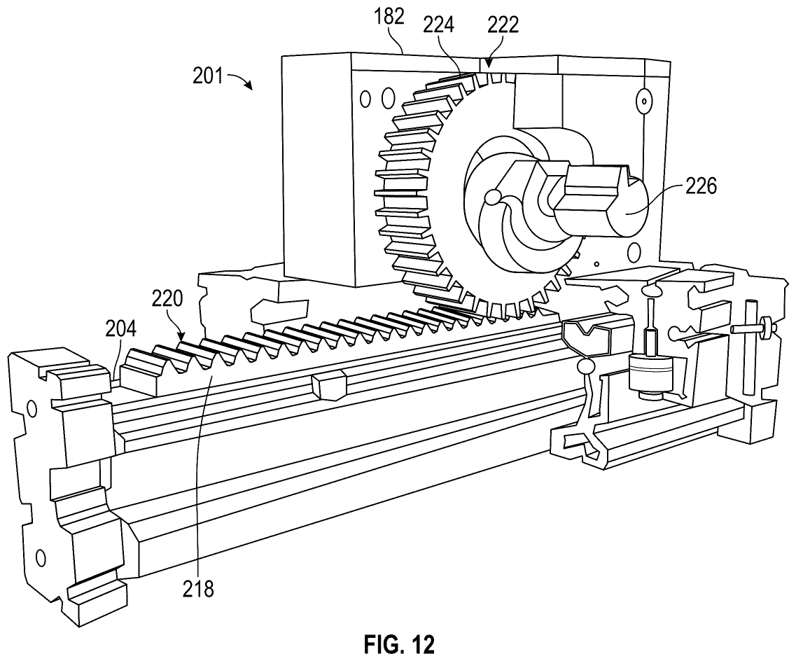

As illustrated in FIG. 5, wherein the deployable ottoman 102 may include a first portion 101 and a second portion 103. At least a first portion 101 of the deployable ottoman 102 may be lifted to a second height above the vehicle floorboard 104. In a number of variations, a linear actuator, for example as shown in FIGS. 11-12, may be operatively connected to the deployable ottoman 102 to lift at least a first portion 101 or all of the deployable ottoman 102. In a number of variations at least a portion of the deployable ottoman 102 may be lifted to an elevated position by an electric motor to adjust the comfort of the occupant having a calf supported by the deployable ottoman.

FIG. 7 illustrates a number of variations, which may include a control system 140 which may include a computing device 142 including electronic processor 144 and a non-transitory digital storage media 146 having written instructions 148 stored thereon executable by the electronic processor 144 to carry out or achieve any act, step, method, or functionality described herein. The control system 140 or a similar control system may be used to operate the vehicle in an autonomous or semi-autonomous manner. A control device 152 may be provided in the passenger cabin 106 of the vehicle 100 such as but not limited to, the display screen 132, a microphone 304, camera 302, or a handheld controller. As illustrated in FIG. 7, in one variation, the control device 152 may include a first input component 154 which may be a button on a handheld device or a widget on a display screen, display, or computer, and may include a second input component 156. In a number of variations, the first input component 154 may be used to send a signal to the control system 140 which may be operatively connected to an electric motor 158 which may be operatively connected to the deployable ottoman 102 to move the deployable ottoman 102 in a first direction which, for example, may be toward the first position 124 (shown in FIGS. 1, and 13-19) and the second input component 156 may be utilized to send a signal to the control system 140 to move the deployable ottoman 102 in a second direction, which may be toward the second position 126 (shown in FIGS. 2-5). The control system 140 may include a communication means 150 such as, but not limited to, an antenna to receive requests to move the deployable ottoman 102 by Wi-Fi, Bluetooth, or radio signals. The control system 140 may also be configured to receive and respond to voice requests to move the deployable ottoman 102. At least one audio speaker or display screen 132 may be operatively connected to the computing device 142 to send a signal to communicate visually or audibly with an occupant of the vehicle 100.

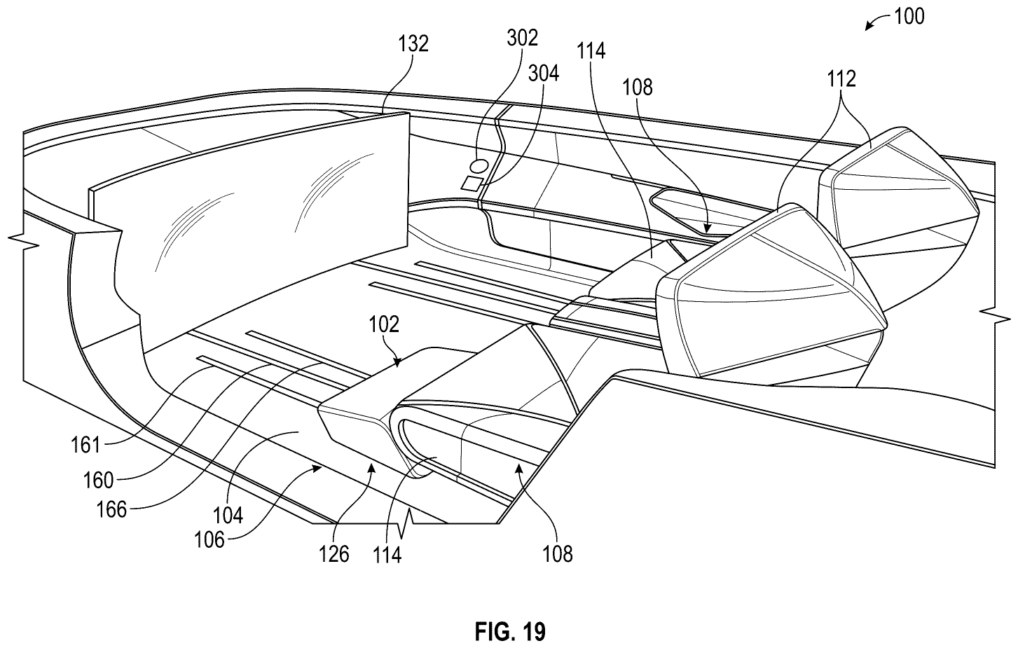

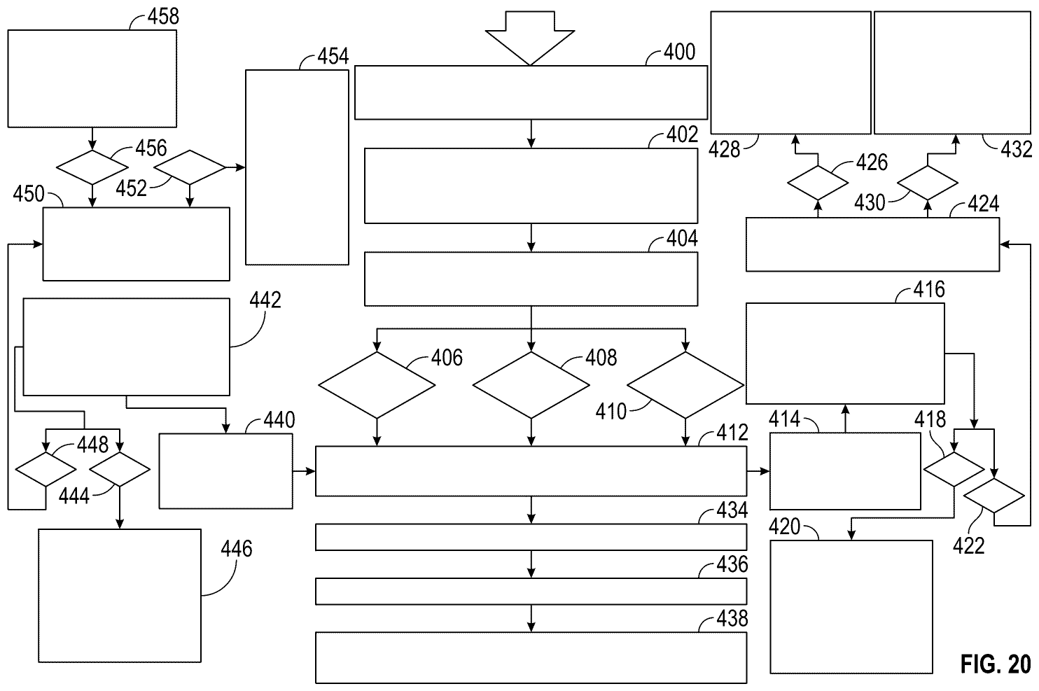

In a number of variations the control system 140 may include written instructions 148 stored on non-transitory digital storage media 146 and executable by the processor 144 to use data from the one or more cameras 302 to make determinations regarding an occupant's height, position of the occupant's legs, and the seating position of the occupant to move the deployable ottoman 102 to various positions, and to raise and lower the deployable ottoman 102 based upon determinations made by the control system 140 and/or with input from the occupant. Control system 140 may be configured to carry out the functionality described in FIGS. 19-20, as will be described in greater detail hereafter.

FIGS. 8-9 illustrate a number of variations which may include a vehicle floorboard 104 having a first track 160, which may include a slot defined by a first vertical wall 162 and a spaced apart second vertical wall 164 formed in the vehicle floorboard 104 extending from a top face 172 to a bottom face 174 of the vehicle floorboard 104. Similarly, a second track 166 may include a second slot formed in the vehicle floorboard 104 defined by a third vertical wall 168 and a spaced apart fourth vertical wall 170 extending from the top face 172 to the bottom face 174 of the vehicle floorboard 104. As illustrated in FIG. 9, a connector 176 extending through the bottom wall 122 of the deployable ottoman 102 and into or through a table 182 operatively connected to the electric motor 158 constructed and arranged to move in a first direction and a second direction to provide linear motion of the deployable ottoman 102 from the first position 124 to the second position 126 and vice versa or anywhere therebetween.

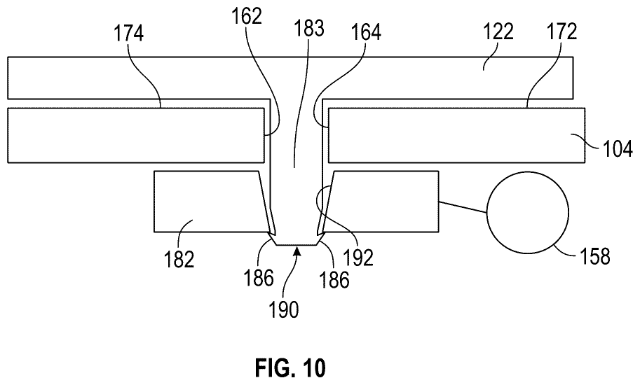

FIG. 10 illustrates a number of variations, which may include the bottom wall 122 of the deployable ottoman 102 having an elongated projection 183 extending therefrom which may include at least one flexible finger 186 at a free end 190 thereof so that the elongated projection 183 may be press fit through a tapered wall 192 formed in the table 182. The deployable ottoman 102 may be moved by a variety of linear movement transport systems including for example, but not limited to, a ball screw linear movement system, a rack and pinion linear movement system, or a timing belt linear movement system.

FIG. 11 illustrates a number of variations which may include a ball screw linear movement system 199 which may include a ball screw 198 having a first end 210 operatively connected to electric motor 158 and having a second end 200 received in a bearing 202 supported by a guide rail 204. The ball screw 198 may extend through a guide block 194 having a ball screw nut 196 therein for engagement with threads of the ball screw 198. The table 182 may be attached to the guide block 194 and may have a tapered wall 192 defining a recess therein or a through hole. The guide block 194 may be L-shaped and may have a bottom surface 205 of the table 182 may slide along a top surface 206 of the guide rail 204, and first surface 207 may slide along an edge 208 of the guide rail 204, and a second surface 209 may slide along a base surface 211 of the guide rail 204.

FIG. 12 illustrates a number of variations which may include a rack and pinion linear movement system 201 which may include a guide rail 204 and a rack 218 attached thereto having a first set of a plurality of spaced apart teeth 220. A pinion gear 222 may include a second set of a plurality of spaced apart teeth 224 for mating with the first set of a plurality of spaced apart teeth 220. A pinion gear shaft 226 may be connected to the pinion gear 222, and a motor (not shown) may be connected to the pinion gear shaft 226 to rotate the pinion gear 222 to linearly move the table 182 operatively connected to the pinion gear 222.

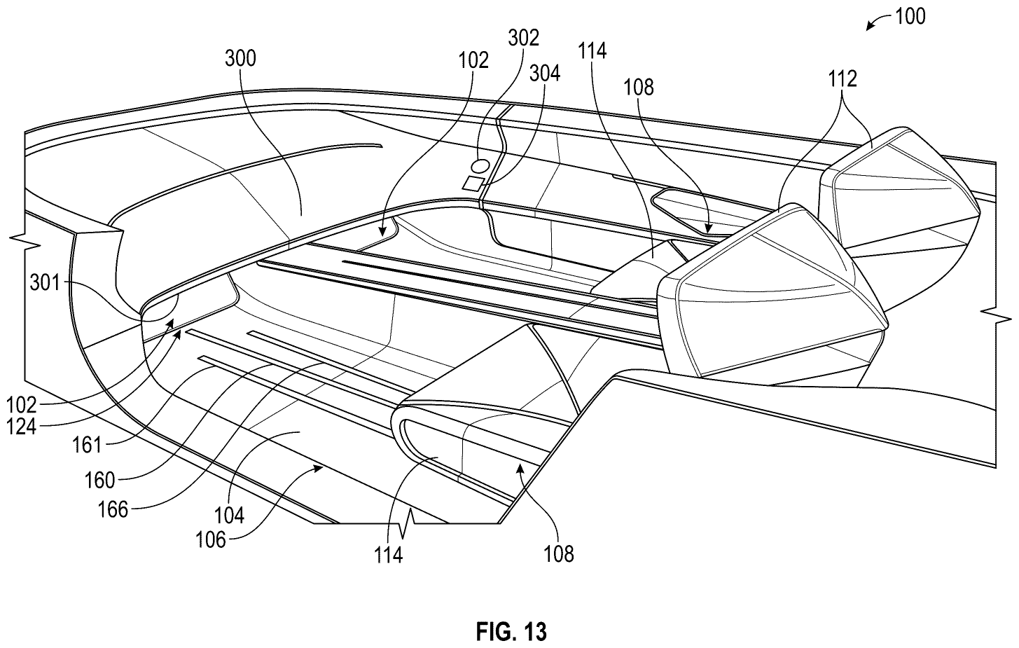

FIG. 13 illustrates a deployable ottoman 102 in a first position 124 wherein the deployable ottoman 102 is in a stored position underneath and behind a lower edge 301 of a trim panel 300 according to a number of variations. The deployable ottoman 102 may be moved from the first position 124 to a second position 126 wherein the deployable ottoman may function as a footrest, the occupant to reach the top wall 120, or the top wall 120 of the deployable ottoman 102 may function as a calf support as previously described herein.

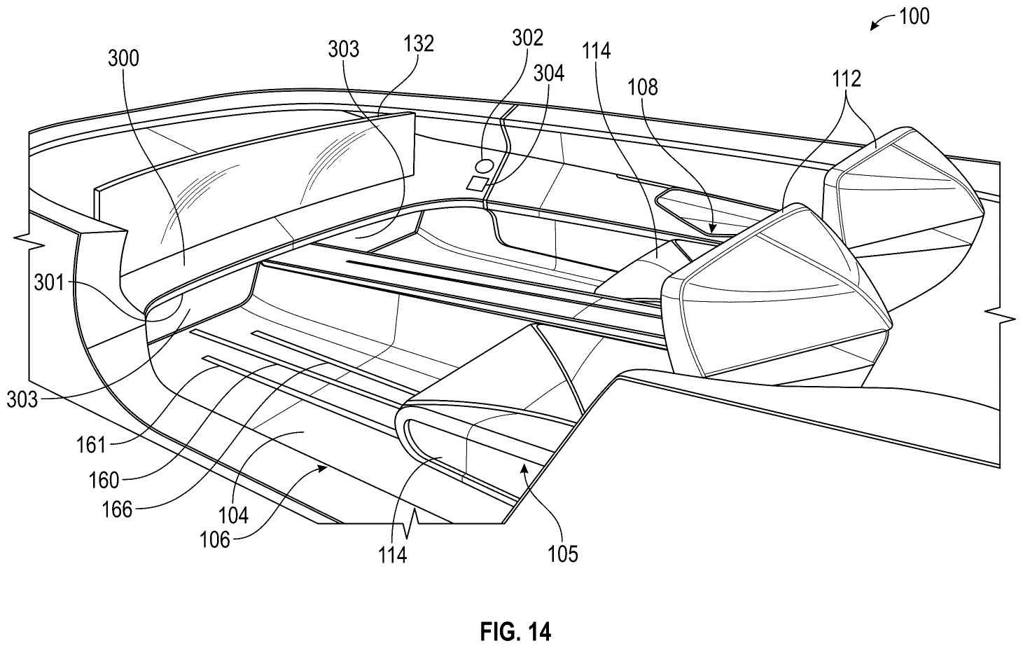

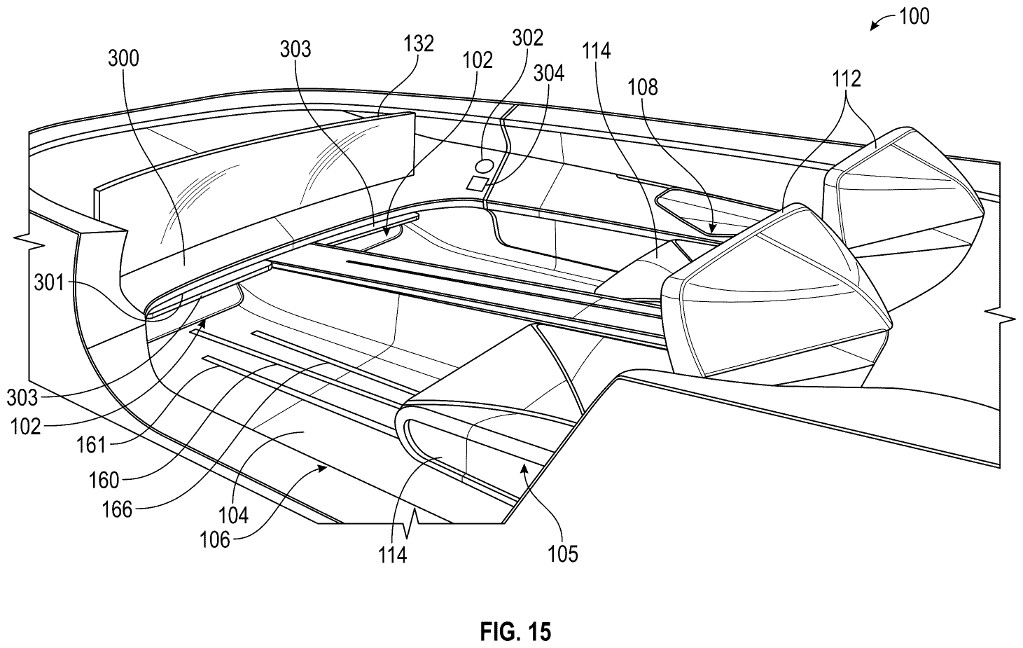

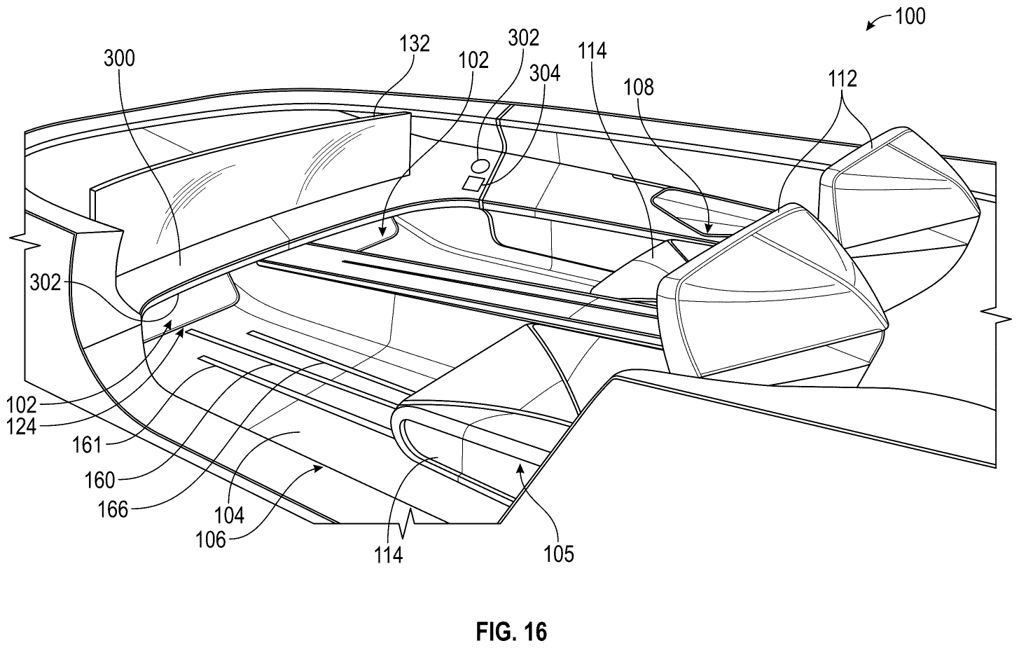

FIG. 14 illustrates a door 303 extending downward from a trim panel 300 to conceal a deployable ottoman 102 behind the door 303. As illustrated in FIG. 15 the door 303 may be moved upward or rotated to reveal a portion of the deployable ottoman 102. As illustrated in FIG. 16, the door 303 may be raised or rotated further so that the deployable ottoman 102 may be moved from the first position 124 to a second position 126 wherein the deployable ottoman may function as a footrest, an occupant to reach the top wall 120, or wherein the top wall 120 of the deployable ottoman 102 may function as a calf support as previously described herein. The control system 140 may be configured to control movement of the door 303.

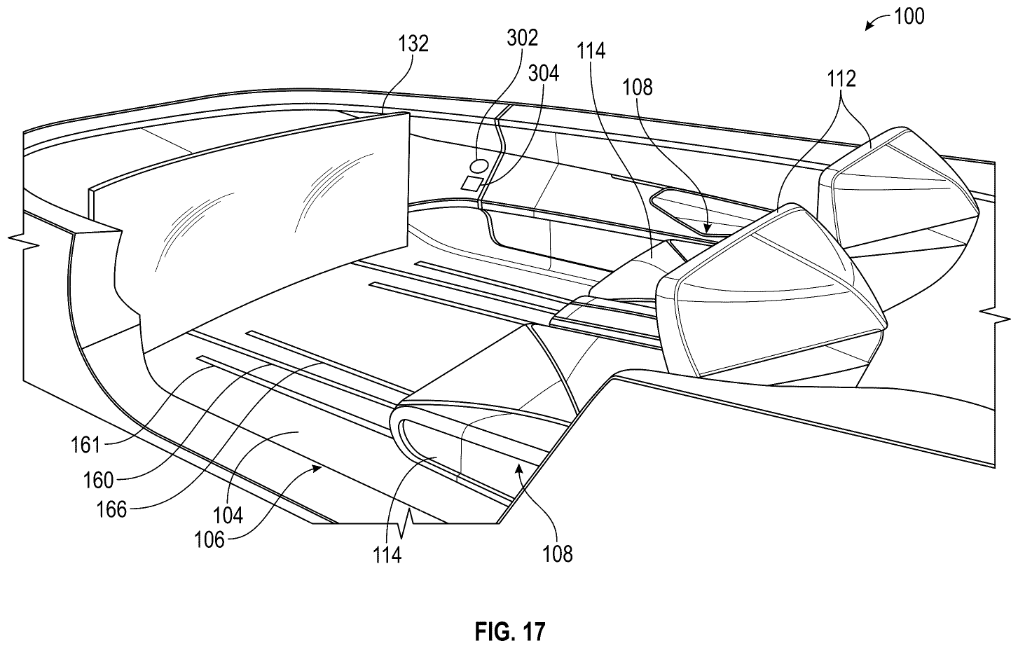

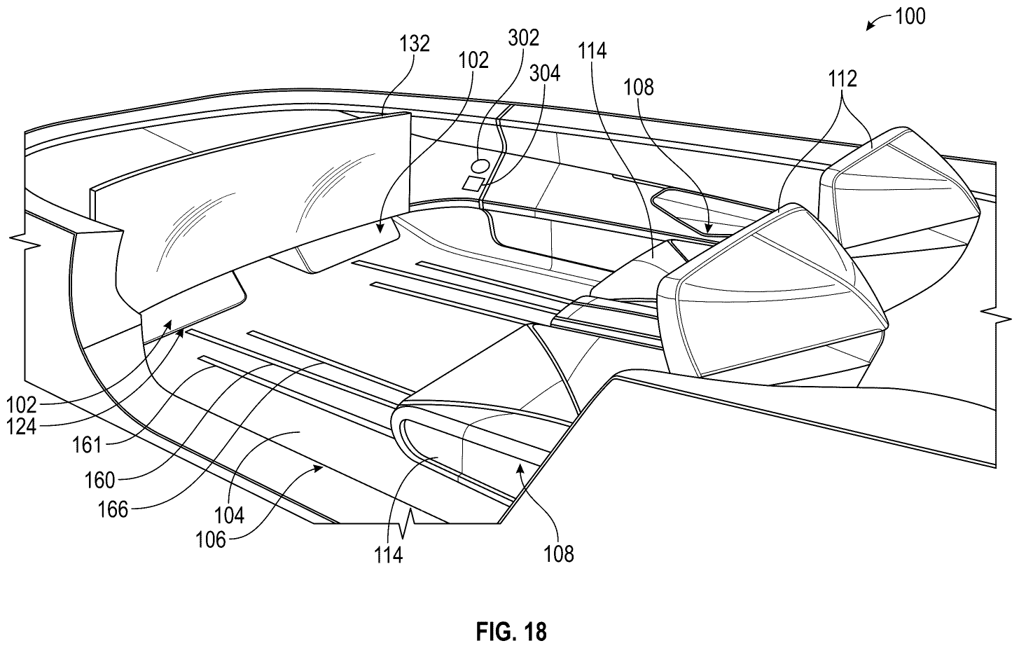

FIG. 17 illustrates a movable display screen 132 which may be moved from a position that conceals the deployable ottoman 102 behind the movable display screen 132 wherein the display screen 132 is near or on the vehicle floorboard 104. As illustrated in FIG. 18, the movable display screen 132 may be moved to a position in which a portion of the deployable ottoman 102 is revealed. As illustrated in FIG. 19 the deployable ottoman 102 may be moved to a second position 126 and the movable display screen 132 may be moved toward or onto the vehicle floorboard 104. The control system 140 may be configured to control movement of the movable display screen 132.

FIG. 19 illustrates a flow chart of a method which may be carried out by a control system 140 described with respect to FIG. 7. The method may start at block 400 wherein an occupant sends a request to the control system 140 for the deployable ottoman using inputs on the display screen, voice command or another input means. The control system 140 receives the request from the occupant and the method proceeds from block 400 to block 402 wherein internal cameras and predictive algorithms in the control system 140 are used to recognize the occupant's body characteristics, legs positions, and seat position. The method proceeds from block 402 to block 404 wherein the control system interacts with the occupant and sends a request asking which deployable ottoman function the occupant desires. At block 406, the control system 140 may receive a request from an occupant for a footrest and in response thereto the method may proceed from block 406 to block 412 wherein the control system 140 receives data from internal cameras and uses the data in predictive algorithms to recalibrate and confirm an optimal position for the deployable ottoman to be placed in response for the request for a footrest. The method may proceed from block 412 to block 440 wherein the control system 140 moves the deployable ottoman to the proper position to function as a footrest. The method may proceed from block 440 to block 442 wherein the control system 140 sends a request to the occupant to confirm that the current position is comfortable as a footrest and in response thereto the control system 140 may receive an input from the occupant at block 444 confirming that the position of the deployable ottoman is comfortable. The method may proceed from block 444 to block 446 wherein the control system 140 goes in standby awaiting a command to move the deployable ottoman to a collapsed or stored position, or other position or function. However, the control system 140 may receive input from an occupant at block 448 that the deployable ottoman is not in a comfortable position to be utilized as a footrest and the method may proceed from block 448 to block 450 wherein the control system 140 recalibrates a revised position for the deployable ottoman to function comfortably as a footrest support and moves the footrest to the revised position and sends a request to the occupant to confirm that the revised position is comfortable. The control system 140 may receive input from the occupant at 452 confirming that the revised position of the deployable ottoman is comfortable for a footrest and in response thereto the method may proceed to block 454 wherein the computer system goes into standby awaiting the command to go back to a collapsed or stored position or other function. However, at block 456 the control system 140 may receive input from the occupant that the deployable ottoman position is not comfortable as a footrest and the method may proceed from block 456 to block 458 wherein the computer system sends a signal to the occupant recommending that fine-tuning be done by the occupant via electronic controller input.

The method may proceed from block 404 to block 408 wherein the computer system receives input from the occupant to move the deployable ottoman to a position to access storage space in the deployable ottoman and in response thereto the method moves from block 408 to block 412 wherein the control system 140 receives data from internal cameras and uses the data in predictive algorithms to recalibrate and confirm an optimal position for the deployable ottoman to be placed in response for the request to access storage of the deployable ottoman. The method may proceed from block 434 to block 436 wherein the control system 140 sends a signal causing the storage door or top wall of the deployable ottoman to automatically open by, for example, an actuator motor (not shown). The method may proceed from block 436 to block 438 wherein the control system goes into standby waiting a command to close the door and go back to a collapsed or stored position or other function.

The method may proceed from block 404 to block 410 wherein the computer system receives input from the occupant to move the deployable ottoman to a position to function as a calf support, and in response thereto the method moves from block 410 to block 412 wherein the control system 140 receives data from internal cameras and uses the data in predictive algorithms to recalibrate and confirm an optimal position for the deployable ottoman to be placed in response for the request to input from the occupant to move the deployable ottoman to a position to function as a calf support. The method may proceed from block 412 to block 414 wherein the control system 140 moves the deployable ottoman to the proper location to function as a calf support. The method may proceed from block 414 to block 416 wherein the control system sends a request for the occupant to confirm that the deployable ottoman is in a proper position to be comfortable as a calf support. The computer system may move from block 416 to block 418 wherein the computer system receives confirmation that the position of the deployable ottoman is comfortable the function as a calf support and in response thereto the method may proceed from block 418 to block 420 wherein the computer system goes into standby waiting for commands to go back to a collapsed or stored position, or other position or function. However, the control system 140 may receive input at block 422 that the deployable ottoman is not in a position to be comfortable as a calf support and the method may proceed from block 422 to block 424 wherein the control system 140 recalibrates a revised position for the deployable ottoman to be moved to function comfortably as a calf support and moves the deployable ottoman to a second position to function as a calf support and sends a signal to the occupant to confirm the same. The method may move from block 422 to block 426 wherein the control system 140 receives input confirming that the second position is comfortable to function as a calf support and the method may proceed from block 426 to block 428 wherein the system goes into standby waiting for commands to go back to a collapsed or stored position, or other position or function. However, the control system 140 may receive input at block 430 that the second position is not comfortable the function as a calf support and the method may proceed from block 430 to block 432 wherein the control system 140 sends a signal to the occupant recommending that fine-tuning to be done by the occupant using electronic controls were input.

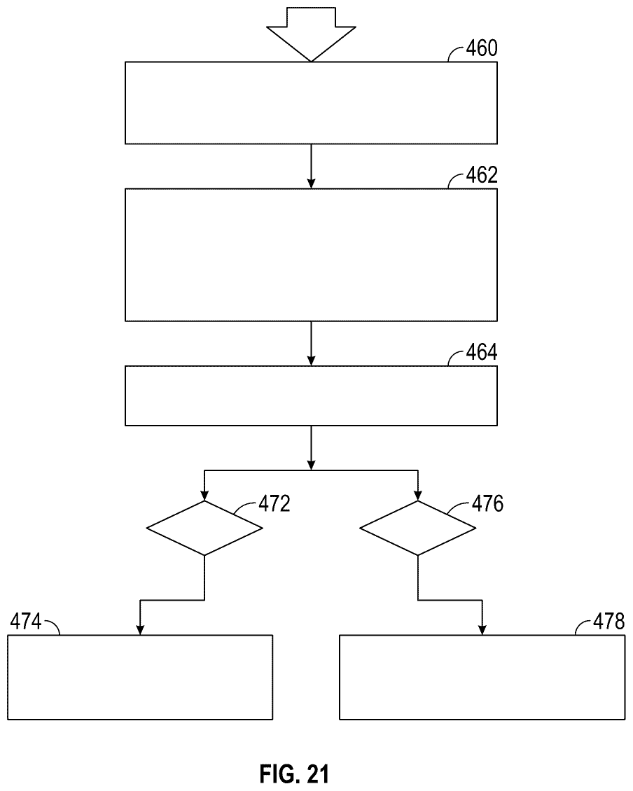

The control system 140 may include written instructions executable by the electronic processor 144 to operate the vehicle 100 in an autonomous or semi-autonomous mode and may provide navigation functionality. Alternatively, another control system (not shown) may be provided to operate the vehicle 100 in an autonomous or semi-autonomous mode and may provide navigation functionality. FIG. 21 illustrates a method which may include, at block 460, the control system 140 or a navigation system determining that the vehicle is approaching a desired destination. The method may proceed from block 460 to block 462 wherein the computer system sends a signal informing an occupant that the vehicle is approaching the destination and the deployable ottoman needs to be moved to allow the occupant to exit the vehicle comfortably. The method proceeds from block 462 to block 464 wherein the control system 140 sends a signal to the occupant to confirm that the occupant is ready for the deployable ottoman to be collapsed or stored, and/or moved to a position to allow the occupant to exit the vehicle comfortably. The control system may receive input from the occupant at block 472 confirming that the occupant is ready for the deployable ottoman to collapse, stored, or moved to a position to allow the occupant to exit the vehicle comfortably. The method may proceed from block 472 to block 474 wherein the control system 140 moves the deployable ottoman to allow the occupant to exit the vehicle and moves the seat back of the occupant to a position to allow the occupant to comfortably exit the vehicle. However, the control system 140 may receive input from the occupant at block 476 that the occupant is not ready to exit the vehicle and the method may proceed from block 476 to block 478 wherein the control system 140 goes into standby waiting for input that the occupant is ready to exit the vehicle and in response thereto the control system moves the seat back to a position to allow the occupant to comfortably exit the vehicle.

At least on camera may be mounted one of an A-pillar, a headliner, an instrument panel or a door trim panel of the vehicle, and wherein the vehicle comprises a navigation system integrated with the ottoman to inform the occupant that the vehicle is approaching its destination and request that the occupant confirm that the occupant is ready for the ottoman to be collapsed or stored to make room for the occupant to exit the vehicle comfortably

Clause 1. A method comprising: providing a computing device comprising electronic processor, a non-transitory storage medium, written instructions stored on the non-transitory storage medium and executable by the electronic processor, the written instructions when executed by the electronic processor perform acts comprising: receiving, by the computing device, a request for activation of a deployable ottoman, wherein the deployable ottoman is operatively connected to at least one track to move along a vehicle floorboard by an electric motor operatively connected to the deployable ottoman; receiving, by the computing device, data from at least one camera and using the data to determine an occupant's body characteristics, leg positions, and seating position; receiving, by the computing device, a request for the deployable ottoman to function as a footrest, to gain access to a storage area defined in the deployable ottoman, or to function as a calf rest; and sending, by the computing device, a signal to the deployable ottoman to move to a position in response to the occupant's body characteristics, leg positions, and seating position and in response to the request for the deployable ottoman to function as a footrest, to gain access to a storage area defined in the deployable ottoman, or to function as a calf rest.

Clause 2. The method as set forth in clause 1 wherein the sending, by the computing device, the signal to the deployable ottoman causes the deployable ottoman to move to a position to function as requested.

Clause 3. The method as set forth in clause 2 further comprising sending, by the computing device, a communication to a vehicle occupant prompting the vehicle occupant to confirm that the deployable ottoman is in a position to function as requested.

Clause 4. The method as set forth in clause 3 further comprising receiving, by the computing device, confirmation that the position of the deployable ottoman is in a position to function as requested.

Clause 5. The method as set forth in clause 4 further comprising putting the computing device in standby mode awaiting a request to move the deployable ottoman to a collapse position, a storage position, another position, or to provide another function.

Clause 6. The method as set forth in clause 3 further comprising receiving, by the computing device, input from the vehicle occupant that the deployable ottoman is not in a position to function as requested.

Clause 7. The method as set forth in clause 6 further comprising determining, by the computing device, a recalibrated position to move the deployable ottoman to function as requested and causing the deployable ottoman to move to the recalibrated position.

Clause 8. The method as set forth in clause 7 further comprising sending, by the computing device, another communication to the vehicle occupant prompting the vehicle occupant to confirm that the deployable ottoman is in a position to function as requested.

Clause 9. The method as set forth in clause 8 further comprising receiving, by the computing device, confirmation that the position of the deployable ottoman is in a position to function as requested and in response thereto putting the computing device in standby mode awaiting a request to move the deployable ottoman to a collapsed position, a storage position, another position, or to provide another function.

Clause 10. The method as set forth in clause 8 further comprising receiving, by the computing device, input from the vehicle occupant that the deployable ottoman is not in a position to function as requested and in response thereto sending a communication to the vehicle occupant recommending fine-tuning the position of the deployable ottoman be done by the vehicle occupant via electronic controls.

Clause 11. A vehicle comprising: a vehicle floorboard having at least one track formed therein, a deployable ottoman operatively connected to the at least one track to move along the vehicle floorboard, an electric motor operatively connected to the deployable ottoman to move the deployable ottoman in a first direction and a second direction, the vehicle having a cabin and at least one camera operatively connected to a control system comprising a computing device comprising an electronic processor, a non-transitory storage medium, written instructions stored on the non-transitory storage medium and executable by the electronic processor, the control system configured to provide functionality comprising: receiving, by the computing device, a request for activation the deployable ottoman; receiving, by the computing device, data from the at least one camera and using the data to recognize an occupant's body characteristics, leg positions, and seating position; receiving, by the computing device, a request for the deployable ottoman to function as a footrest, to gain access to a storage area defined in the deployable ottoman, or to function as a calf rest; and sending, by the computing device, a signal to the deployable ottoman to move to a position in response to the occupant's body characteristics, leg positions, and seating position and in response to the request for the deployable ottoman to function as a footrest, to gain access to a storage area defined in the deployable ottoman, or to function as a calf rest.

Clause 12. The vehicle as set forth in clause 11 wherein the sending, by the computing device, the signal to the deployable ottoman causes the deployable ottoman to move to a position to function as requested.

Clause 13. The vehicle as set forth in clause 12 further comprising sending, by the computing device, a communication to an occupant of the vehicle prompting the occupant to confirm that the deployable ottoman is in a position to function as requested.

Clause 14. The vehicle as set forth in clause 13 further comprising receiving, by the computing device, confirmation that the position of the deployable ottoman is in a position to function as requested.

Clause 15. The vehicle as set forth in clause 14 further comprising putting the computing device in standby mode waiting for a request to move the deployable ottoman to a collapse position, a storage position, another position, or to provide another function.

Clause 16. The vehicle as set forth in clause 13 further comprising receiving, by the computing device, input from the occupant of the vehicle that the deployable ottoman is not in a position to function as requested.

Clause 17. The vehicle as set forth in clause 16 further comprising determining, by the computing device, a recalibrated position to move the deployable ottoman to function as requested and causing the deployable ottoman to move to the recalibrated position.

Clause 18. The vehicle as set forth in clause 17 further comprising receiving, by the computing device, confirmation that the position of the deployable ottoman is in a position to function comfortably as requested and in response thereto putting the computing device in standby mode waiting for a request to move the deployable ottoman to a collapse position, a storage position, another position, or to provide another function.

Clause 19. The vehicle as set forth in clause 17 further comprising receiving, by the computing device, input from the occupant that the deployable ottoman is not in a position to function as requested and in response thereto sending a communication to the occupant recommending fine-tuning the position of the deployable ottoman be done by the occupant via electronic controls.

Clause 20. A vehicle comprising: a vehicle floorboard having at least one track formed therein, a deployable ottoman operatively connected to the at least one track to move along the vehicle floorboard, an electric motor operatively connected to the deployable ottoman to move the deployable ottoman in a first direction and a second direction, the vehicle having a cabin and at least one camera operatively connected to a control system comprising a computing device comprising an electronic processor, a non-transitory storage medium, written instructions stored on the non-transitory storage medium and executable by the electronic processor, the control system configured to provide functionality comprising: receiving, by the computing device, a request for activation the deployable ottoman; receiving, by the computing device, data from the at least one camera and using the data to recognize an occupant's body characteristics, leg positions, and seating position; receiving, by the computing device, a request for the deployable ottoman to function as a footrest, to gain access to a storage area defined in the deployable ottoman, or to function as a calf rest; and sending, by the computing device, a signal to the deployable ottoman to move from a first position to a second position in response to the occupant's body characteristics, leg positions, and seating position and in response to the request for the deployable ottoman to function as a footrest, to gain access to a storage area defined in the deployable ottoman, or to function as a calf rest; wherein the vehicle includes at least one of a display screen, a trim panel, a door, or a movable display screen, and in the first position the deployable ottoman is at least one of: flush with the display screen or the trim panel positioned in front of a seat in the vehicle, underneath the trim panel or the display screen positioned in front of the seat in the vehicle, hidden behind the door positioned underneath the display screen or the trim panel positioned in front of the seat in the vehicle, or hidden behind the movable display screen in front of the seat in the vehicle; and wherein the at least on camera mounted one of an A-pillar, a headliner, an instrument panel or a door trim panel of the vehicle, and wherein the vehicle comprises a navigation system integrated with the ottoman to inform the occupant that the vehicle is approaching its destination and request that the occupant confirm that the occupant is ready for the ottoman to be collapsed or stored to make room for the occupant to exit the vehicle comfortably

While at least one variation has been presented in the foregoing detailed description, it should be appreciated that a vast number of variations exist. It should also be appreciated that the variation or variations are only examples, and are not intended to limit the scope, applicability, or configuration of the disclosure in any way. Rather, the foregoing detailed description will provide those skilled in the art with a convenient road map for implementing the illustrative variation or variations. It should be understood that various changes can be made in the function and arrangement of elements without departing from the scope of the disclosure as set forth in the appended claims and the legal equivalents thereof.

What is claimed is:

1. A method comprising:
providing a computing device comprising electronic processor, a non-transitory storage medium, written instructions stored on the non-transitory storage medium and executable by the electronic processor, the written instructions when executed by the electronic processor perform acts comprising:
receiving, by the computing device, a request for activation of a deployable ottoman, wherein the deployable ottoman is operatively connected to at least one track to move along a vehicle floorboard by an electric motor operatively connected to the deployable ottoman;
receiving, by the computing device, data from at least one camera and using the data to determine an occupant's body characteristics, leg positions, and seating position;
receiving, by the computing device, a request for the deployable ottoman to function as a footrest, to gain access to a storage area defined in the deployable ottoman, or to function as a calf rest; and
sending, by the computing device, a signal to the deployable ottoman to move to a position in response to the occupant's body characteristics, leg positions, and seating position and in response to the request for the deployable ottoman to function as a footrest, to gain access to a storage area defined in the deployable ottoman, or to function as a calf rest.

2. The method as set forth in claim 1 wherein the sending, by the computing device, the signal to the deployable ottoman causes the deployable ottoman to move to a position to function as requested.

3. The method as set forth in claim 2 further comprising sending, by the computing device, a communication to a vehicle occupant prompting the vehicle occupant to confirm that the deployable ottoman is in a position to function as requested.

4. The method as set forth in claim 3 further comprising receiving, by the computing device, confirmation that the position of the deployable ottoman is in a position to function as requested.

5. The method as set forth in claim 4 further comprising putting the computing device in standby mode awaiting a request to move the deployable ottoman to a collapse position, a storage position, another position, or to provide another function.

6. The method as set forth in claim 3 further comprising receiving, by the computing device, input from the vehicle occupant that the deployable ottoman is not in a position to function as requested.

7. The method as set forth in claim 6 further comprising determining, by the computing device, a recalibrated position to move the deployable ottoman to function as requested and causing the deployable ottoman to move to the recalibrated position.

8. The method as set forth in claim 7 further comprising sending, by the computing device, another communication to the vehicle occupant prompting the vehicle occupant to confirm that the deployable ottoman is in a position to function as requested.

9. The method as set forth in claim 8 further comprising receiving, by the computing device, confirmation that the position of the deployable ottoman is in a position to function as requested and in response thereto putting the computing device in standby mode awaiting a request to move the deployable ottoman to a collapsed position, a storage position, another position, or to provide another function.

10. The method as set forth in claim 8 further comprising receiving, by the computing device, input from the vehicle occupant that the deployable ottoman is not in a position to function as requested and in response thereto sending a communication to the vehicle occupant recommending fine-tuning the position of the deployable ottoman be done by the vehicle occupant via electronic controls.

11. A vehicle comprising:
a vehicle floorboard having at least one track formed therein, a deployable ottoman operatively connected to the at least one track to move along the vehicle floorboard, an electric motor operatively connected to the deployable ottoman to move the deployable ottoman in a first direction and a second direction, the vehicle having a cabin and at least one camera operatively connected to a control system comprising a computing device comprising an electronic processor, a non-transitory storage medium, written instructions stored on the non-transitory storage medium and executable by the electronic processor, the control system configured to provide functionality comprising:
receiving, by the computing device, a request for activation the deployable ottoman;
receiving, by the computing device, data from the at least one camera and using the data to recognize an occupant's body characteristics, leg positions, and seating position;
receiving, by the computing device, a request for the deployable ottoman to function as a footrest, to gain access to a storage area defined in the deployable ottoman, or to function as a calf rest; and
sending, by the computing device, a signal to the deployable ottoman to move to a position in response to the occupant's body characteristics, leg positions, and seating position and in response to the request for the deployable ottoman to function as a footrest, to gain access to a storage area defined in the deployable ottoman, or to function as a calf rest.

12. The vehicle as set forth in claim 11 wherein the sending, by the computing device, the signal to the deployable ottoman causes the deployable ottoman to move to a position to function as requested.

13. The vehicle as set forth in claim 12 further comprising sending, by the computing device, a communication to an occupant of the vehicle prompting the occupant to confirm that the deployable ottoman is in a position to function as requested.

14. The vehicle as set forth in claim 13 further comprising receiving, by the computing device, confirmation that the position of the deployable ottoman is in a position to function as requested.

15. The vehicle as set forth in claim 14 further comprising putting the computing device in standby mode waiting for a request to move the deployable ottoman to a collapse position, a storage position, another position, or to provide another function.

16. The vehicle as set forth in claim 13 further comprising receiving, by the computing device, input from the occupant of the vehicle that the deployable ottoman is not in a position to function as requested.

17. The vehicle as set forth in claim 16 further comprising determining, by the computing device, a recalibrated position to move the deployable ottoman to function as requested and causing the deployable ottoman to move to the recalibrated position.

18. The vehicle as set forth in claim 17 further comprising receiving, by the computing device, confirmation that the position of the deployable ottoman is in a position to function comfortably as requested and in response thereto putting the computing device in standby mode waiting for a request to move the deployable ottoman to a collapse position, a storage position, another position, or to provide another function.

19. The vehicle as set forth in claim 17 further comprising receiving, by the computing device, input from the occupant that the deployable ottoman is not in a position to function as requested and in response thereto sending a communication to the occupant recommending fine-tuning the position of the deployable ottoman be done by the occupant via electronic controls.

20. A vehicle comprising:
a vehicle floorboard having at least one track formed therein, a deployable ottoman operatively connected to the at least one track to move along the vehicle floorboard, an electric motor operatively connected to the deployable ottoman to move the deployable ottoman in a first direction and a second direction, the vehicle having a cabin and at least one camera operatively connected to a control system comprising a computing device comprising an electronic processor, a non-transitory storage medium, written instructions stored on the non-transitory storage medium and executable by the electronic processor, the control system configured to provide functionality comprising:
receiving, by the computing device, a request for activation the deployable ottoman;
receiving, by the computing device, data from the at least one camera and using the data to recognize an occupant's body characteristics, leg positions, and seating position;
receiving, by the computing device, a request for the deployable ottoman to function as a footrest, to gain access to a storage area defined in the deployable ottoman, or to function as a calf rest; and
sending, by the computing device, a signal to the deployable ottoman to move from a first position to a second position in response to the occupant's body characteristics, leg positions, and seating position and in response to the request for the deployable ottoman to function as a footrest, to gain access to a storage area defined in the deployable ottoman, or to function as a calf rest;
wherein the vehicle include at least one of a display screen, a trim panel, a door, or a movable display screen, and in the first position the deployable ottoman is at least one of: flush with the display screen or the trim panel positioned in front of a seat in the vehicle, underneath the trim panel or the display screen positioned in front of the seat in the vehicle, hidden behind the door positioned underneath the display screen or the trim panel positioned in front of the seat in the vehicle, or hidden behind the movable display screen in front of the seat in the vehicle; and
wherein the at least on camera is mounted one of an A-pillar, a headliner, an instrument panel or a door trim panel of the vehicle, and wherein the vehicle comprises a navigation system integrated with the ottoman to inform the occupant that the vehicle is approaching its destination and request that the occupant confirm that the occupant is ready for the ottoman to be collapsed or stored to make room for the occupant to exit the vehicle comfortably.
